(19) United States
(12) Patent Application Publication
(10) Pub. No.: US 2026/0135197 A1
(43) Pub. Date: May 14, 2026

(54) LITHIUM SECONDARY BATTERY AND METHOD OF MANUFACTURING THE SAME

(71) Applicant: SK On Co., Ltd., Seoul (KR)

(72) Inventor: Seung Min LEE, Daejeon (KR)

(21) Appl. No.: 19/372,302

(22) Filed: Oct. 29, 2025

(30) Foreign Application Priority Data
Nov. 14, 2024 (KR) 10-2024-0162308

(51) Int. Cl. H01M 10/659; H01M 10/052; H01M 10/647; H01M 50/105; H01M 50/474; H01M 50/486

(52) U.S. Cl. CPC H01M 10/659; H01M 10/052; H01M 10/647; H01M 50/105; H01M 50/474; H01M 50/486

(57) ABSTRACT

This disclosure provides lithium secondary battery and method of manufacturing the same. The lithium secondary battery comprises an electrode assembly comprising an electrode, a battery case housing the electrode assembly, and a polymer resin pack containing a phase change material therein. The polymer resin pack is disposed within the battery case.

### CROSS-REFERENCE TO RELATED APPLICATION(S)

This patent document claims the priority and benefits of Korean Patent Application No. 10-2024-0162308 filed on Nov. 14, 2024, the disclosure of which is incorporated herein by reference in its entirety.

### TECHNICAL FIELD

The disclosure and implementations disclosed in this patent document generally relate to a lithium secondary battery and a method of manufacturing the same.

### BACKGROUND

Recently, active research is being conducted into electric vehicles (EVs) as a potential replacement for fossil fuel-powered vehicles, a major source of air pollution. Lithium secondary batteries, with high discharge voltage and output stability thereof, are primarily used as power sources for these EVs.

However, lithium secondary batteries generate a large amount of heat during the charging and discharging processes. If this heat is not effectively dissipated, it may lead to battery deterioration. During a heat dissipation process, if some lithium secondary battery cells overheat due to various causes, there is a risk of a chain reaction of fires or explosions. Therefore, there is a need for technologies that may suppress internal temperature rise in lithium secondary batteries during normal charge and discharge conditions, thereby improving battery lifespan characteristics. Furthermore, technologies that may suppress rapid temperature rises under abnormal conditions, thereby enhancing battery thermal stability, are needed.

### SUMMARY

The present disclosure may be implemented in some embodiments to provide a lithium secondary battery with excellent thermal stability.

An aspect of the present disclosure is to provide a lithium secondary battery with excellent lifespan characteristics.

In some embodiments of the present disclosure, a lithium secondary battery comprises an electrode assembly comprising an electrode; a battery case housing the electrode assembly; and a polymer resin pack containing a phase change material therein. The polymer resin pack is disposed within the battery case.

The phase change material may have a melting point of 40 to 70° C.

The phase change material may comprise a paraffin having 20 to 40 carbon atoms.

The phase change material may further comprise a polymer structure and an additive.

The polymer structure may comprise at least one of an acrylic polymer matrix selected from the group consisting of polymethylmethacrylate, polyacrylate, and polymethacrylic acid, and a polyolefin polymer matrix selected from the group consisting of polyethylene, polypropylene, and polybutene.

The additive may comprise at least one selected from the group consisting of silica (SiO₂), glass fiber, alumina (Al₂O₃), copper (Cu), graphene, carbon nanotubes, dibutyl hydroxy toluene, and polymer wax.

The phase change material may comprise 49.5 to 99% by weight of the paraffin, 0.5 to 50% by weight of the polymer structure, and 0.5 to 20% by weight of the additive, based on a total weight of the phase change material.

The polymer resin pack may comprise a thermosetting polymer resin.

The thermosetting polymer resin may comprise at least one selected from the group consisting of an epoxy resin and a phenol resin.

The polymer resin pack may have a thickness of 100 to 500 μm.

The lithium secondary battery may comprise an electrode tab-electrode lead junction in which an electrode tab connected from the electrode assembly and an electrode lead are joined, and the polymer resin pack may be disposed between the electrode tab-electrode lead junction and the battery case.

The polymer resin pack may be disposed between an outermost surface of the electrode assembly and the battery case.

In some embodiments of the present disclosure, a method of manufacturing a lithium secondary battery comprises preparing a polymer resin pack containing a phase change material therein; and disposing the polymer resin pack inside a battery case in which an electrode assembly comprising an electrode is housed.

The preparing the polymer resin pack may comprise melting a phase change material; solidifying the melted phase change material into a specific shape; and disposing the solidified phase change material inside the polymer resin pack.

The preparing the polymer resin pack may comprise melting the phase change material; injecting the melted phase change material into the polymer resin pack; and solidifying the phase change material injected into the polymer resin pack.

### BRIEF DESCRIPTION OF DRAWINGS

Certain aspects, features, and advantages of the present disclosure are illustrated by the following detailed description with reference to the accompanying drawings.

FIG. 1 is a cross-sectional view schematically illustrating a phase change material contained within a polymer resin pack according to an embodiment.

FIG. 2 is a cross-sectional view schematically illustrating a lithium secondary battery in which a polymer resin pack according to an embodiment is disposed between an electrode tab-electrode lead junction and a battery case.

FIG. 3 is a cross-sectional view schematically illustrating a lithium secondary battery in which a polymer resin pack according to an embodiment is disposed between the outermost surface of an electrode assembly and an battery case.

FIG. 4 is a cross-sectional view schematically illustrating a lithium secondary battery in which a polymer resin pack according to an embodiment is disposed between an electrode tab-electrode lead junction and a battery case and between the outermost surface of an electrode assembly and an battery case.

FIG. 5 is a graph illustrating temperature changes during discharge in a high-temperature environment for a lithium secondary battery according to an embodiment of the present disclosure and a lithium secondary battery according to a comparative example.

FIG. 6 is a graph illustrating temperature changes during thermal runaway due to penetration of a lithium secondary battery according to an embodiment of the present disclosure and a lithium secondary battery according to a comparative example.

### DETAILED DESCRIPTION

Features of the present disclosure disclosed in this patent document are described by example embodiments with reference to the accompanying drawings.

Hereinafter, the technology disclosed in this specification and its implementation examples are described in detail. However, the embodiments of the technology may be modified in various ways and are not limited to the implementation examples described below. Furthermore, the technology disclosed in this specification may be applied not only within the configurations of the implementation examples described below, but also may be configured by selectively combining all or part of respective implementation examples so that various modifications may be made.

As described above, there is a need for technology that may improve battery lifespan characteristics and thermal stability by suppressing the temperature rise of lithium secondary batteries during normal charge and discharge or by suppressing rapid temperature increases under abnormal conditions. In detail, lithium secondary batteries used in electric vehicles may generate a large amount of heat within the battery when high current is applied in a short period of time or high output is discharged due to rapid charging. Furthermore, high-capacity, medium-to large-sized lithium secondary batteries may be comprised of multiple cells to form modules or packs. Accordingly, in abnormal situations such as heating, overcharging, penetration, and short circuits, when a single cell experiences thermal runaway, the heat may transfer to adjacent cells, potentially leading to a chain reaction of thermal runaway.

According to an embodiment, to prevent thermal runaway transfer in a lithium secondary battery, a thermally conductive pad may be applied to a module or pack comprised of multiple lithium secondary battery cells. According to another embodiment, a phase change material may be applied to a connection portion of a unit cell tab and a bus bar that electrically connects the tabs of a unit cell within a module of a lithium secondary battery. However, the structure of such a lithium secondary battery module or pack may not immediately suppress the temperature rise within the unit cell where heat is generated, which may limit cooling performance and may limit the prevention of thermal runaway transfer to adjacent cells.

Conversely, a lithium secondary battery according to an embodiment may comprise a phase change material capable of absorbing a large amount of heat within each unit cell. Therefore, the heat generated within the unit cell may be effectively absorbed. Accordingly, the temperature rise of a lithium secondary battery may be immediately suppressed during rapid charging and high-power discharge, or when thermal runaway occurs under abnormal conditions, thereby improving the thermal stability and lifespan characteristics of the lithium secondary battery.

In detail, a lithium secondary battery according to an embodiment comprises an electrode assembly comprising an electrode, a battery case housing the electrode assembly, and a polymer resin pack containing a phase change material therein. The polymer resin pack may be disposed within the battery case.

The electrode assembly comprises a cathode and an anode, and the shape thereof is not particularly limited. An electrode assembly according to an embodiment may further comprise a separator between the cathode and the anode. An electrode assembly according to another embodiment may further comprise a solid electrolyte layer between the cathode and the anode.

According to example embodiments, the electrode assembly may be formed by repeatedly disposing the cathode, anode, and separator. In some embodiments, the electrode assembly may be of a winding type, a stacking type, a z-folding type, or a stack-folding type.

The electrode may be a cathode or an anode, and the structure thereof is not particularly limited. According to example embodiments, electrode tabs (cathode tab and anode tab) may protrude from the cathode current collector and the anode current collector, respectively, and extend to one side of the case. The electrode tabs may be fused to the one side of the case and connected to electrode leads (cathode lead and anode lead) that extend or are exposed outside the case.

The battery case may accommodate the electrode assembly, and the shape thereof is not particularly limited. According to example embodiments, examples of the battery case may comprise a pouch-type case, a prismatic case, a cylindrical case, a coin-type case, and the like.

A secondary battery according to an embodiment may comprise a phase change material capable of absorbing a large amount of heat within the cell. The phase change material is a material that changes phase when a predetermined temperature is reached due to thermal change, and may refer to a material that changes from a solid to a liquid state or from a solid to a gaseous state. For example, the phase change material may be a material that is solid at room temperature (approximately 25° C.) and melts and changes to a liquid state when a predetermined temperature is reached.

The phase change material may have a melting point of 40 to 70° C. For example, the phase change material may have a melting point of 40 to 65° C., 40 to 60° C., 45 to 70° C., 45 to 65° C., 45 to 60° C., or 50 to 55° C. When the temperature of a lithium secondary battery increases due to heat generation during operation, the solid-phase change material may absorb heat corresponding to the specific heat required for the temperature increase. When the temperature of the lithium secondary battery rises and reaches the melting point of the phase change material, the phase change material undergoes a phase change from a solid to a liquid phase, absorbing heat corresponding to the latent heat required for the phase change. Therefore, by using a phase change material having a melting point within the above temperature range, the temperature increase of the lithium secondary battery may be suppressed and an appropriate temperature may be maintained.

If the melting point of the phase change material is less than 40° C., even a small amount of heat generated during operation of the lithium secondary battery may cause the phase change material to reach a melting point thereof and begin to liquefy, thus failing to sufficiently suppress the temperature rise of the lithium secondary battery. If the melting point of the phase change material exceeds 70° C., the phase change material may not absorb a large amount of heat until the temperature of the lithium secondary battery reaches the melting point thereof, thus failing to sufficiently suppress the temperature rise of the lithium secondary battery.

The phase change material may have a specific heat of 2.0 to 2.5 J/g° C. in the solid state. For example, the phase change material may have a specific heat of 2.1 to 2.3 J/g° C. in the solid state. If the specific heat of the phase change material in the solid state is less than 2.0 J/g° C., the amount of heat that the solid phase change material may absorb is small, and thus, even a small amount of heat generation may quickly reach the melting point of the phase change material. Accordingly, even a small amount of heat generation may cause the phase change material to undergo a phase change and become liquid, which may not sufficiently suppress the temperature rise of the lithium secondary battery.

The phase change material may have a latent heat of fusion of 140 to 300 J/g. The latent heat of fusion of the phase change material may refer to the amount of heat per unit mass required for the phase change material to change from a solid state to a liquid state. For example, the latent heat of fusion of the phase change material may be 150 to 290, 160 to 270, 170 to 250, 180 to 230, or 190 to 210 J/g. If the latent heat of fusion of the phase change material is less than 140 J/g, the heat absorbed during the phase change process may not be sufficiently suppressed, resulting in insufficient heat absorption and thus insufficient temperature suppression of the lithium secondary battery.

The phase change material may have a specific heat in the liquid state of 1.5 to 2.5 J/g° C. For example, the phase change material may have a specific heat in the liquid phase of 1.6 to 2.4, 1.7 to 2.3, 1.8 to 2.2, or 1.9 to 2.1 J/g° C. If the specific heat in the liquid phase of the phase change material is less than 1.5 J/g° C., it may not sufficiently absorb heat during the temperature rise process after melting, thereby failing to sufficiently suppress the temperature rise of the lithium secondary battery.

The phase change material is not limited as long as it may effectively absorb heat during the charge/discharge process of the lithium secondary battery or under abnormal conditions. For example, the phase change material may comprise paraffin in the CₙH₂ₙ₊₂ form. When using paraffin as the phase change material, the melting point and latent heat of fusion vary depending on the carbon chain length of the paraffin, and thus, the carbon chain length may be selected based on the thermal management objectives of the lithium secondary battery. In more detail, the phase change material may comprise paraffin having 20 to 40 carbon atoms. By using paraffin within the above carbon atom range as a phase change material, the heat generated by a lithium secondary battery may be effectively absorbed, thereby suppressing temperature increases.

The phase change material may further comprise a polymer structure and an additive.

If the phase change material further comprises a polymer structure, the paraffin may form a complex with the polymer structure and remain stable. The polymer structure is not limited as long as it forms a complex with the paraffin to enhance the stability of the phase change material. In detail, the polymer structure may comprise at least one of an acrylic polymer matrix selected from the group consisting of polymethylmethacrylate, polyacrylate, and polymethacrylic acid, and a polyolefin polymer matrix selected from the group consisting of polyethylene, polypropylene, and polybutene.

If the phase change material comprises an additive, the physical properties of the phase change material may be improved. In detail, the phase change material may comprise an additive that improves mechanical stability, thermal conductivity, and chemical stability. For example, the additive may comprise at least one selected from the group consisting of silica (SiO₂), glass fiber, alumina (Al₂O₃), copper (Cu), graphene, carbon nanotubes, dibutyl hydroxy toluene, and polymer wax.

If the additive comprises silica or glass fiber, it may suppress the fluidity of the paraffin and enhance the bonding strength with the structural polymer, thereby improving the mechanical stability of the phase change material and preventing leakage and deformation. If the additive comprises alumina, copper, graphene, or carbon nanotubes, it may enhance the thermal conductivity of the phase change material, thereby accelerating the heat accumulation and release rate during the phase change process. If the additive comprises an antioxidant such as dibutyl hydroxytoluene or a UV stabilizer, it may prevent the performance degradation of the paraffin due to deterioration and oxidation, thereby extending a lifespan thereof. When the additive comprises a polymer wax such as polymethyl methacrylate, it may maintain high viscosity even in the liquid phase during the phase change of paraffin, thereby preventing paraffin leakage. The polymer wax such as polymethyl methacrylate may also be comprised as an additive to improve the physical properties of paraffin, separate from the polymer structure.

The phase change material may comprise 49.5 to 99% by weight of the paraffin, 0.5 to 50% by weight of the polymer structure, and 0.5 to 20% by weight of the additive, based on the total weight of the phase change material. By having a composition within the above-described range, the phase change material may stably and effectively suppress the temperature rise of a lithium secondary battery.

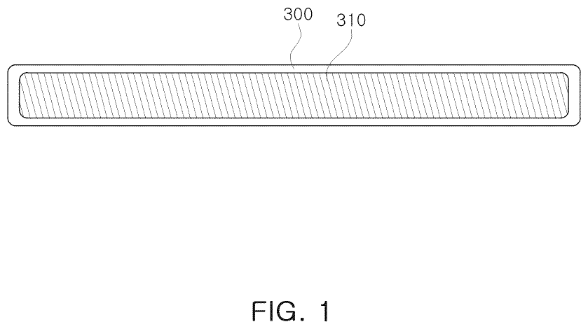

A lithium secondary battery according to an embodiment may comprise a polymer resin pack containing the phase change material and disposed within a battery case. The shape of the polymer resin pack is not particularly limited, as long as it may contain the phase change material. For example, the polymer resin pack may have a structure in which a polymer film encapsulates (packages) a phase change material in an envelope-like manner. FIG. 1 is a cross-sectional view schematically illustrating a phase change material contained within a polymer resin pack according to an embodiment.

The polymer resin pack 300 may contain the phase change material 310 and may be disposed in the empty space within the battery case 400. By containing the phase change material 310 within the polymer resin pack 300 while being disposed in the empty space within the battery case 400, rather than directly being applied within the battery case 400 or on the electrode assembly 100, the dead space of the lithium secondary battery may be effectively utilized. Furthermore, since a large amount of phase change material 310 may be incorporated into the lithium secondary battery cell, temperature rise in the lithium secondary battery may be effectively suppressed.

The polymer resin pack 300 may be present in an amount of 1 to 20% by weight based on the total weight of the electrode assembly 100. In detail, the polymer resin pack 300 may be present in an amount of 5% by weight or more, or 15% by weight or less, based on the total weight of the electrode assembly 100. In this case, the weight of the polymer resin pack 300 may comprise the weight of the phase change material 310 contained within it. If the polymer resin pack 300 ratio is less than 1% by weight, the phase change material 310 content, which absorbs heat within the battery, may be insufficient, failing to sufficiently suppress the temperature rise of the lithium secondary battery. Furthermore, if the polymer resin pack 300 ratio exceeds 20% by weight, the electrode assembly 100 ratio may be reduced, making it difficult to secure the energy density of the lithium secondary battery.

The polymer resin pack 300 may comprise a thermosetting polymer resin. For example, the thermosetting polymer resin may comprise at least one selected from the group consisting of epoxy resin and phenol resin. For example, the polymer resin pack 300 may comprise an epoxy resin. When the polymer resin pack 300 comprises the thermosetting polymer resin described above, it exhibits high mechanical strength, heat resistance, chemical resistance, and electrical insulation properties, allowing it to stably accommodate the phase change material 310. Furthermore, even if the phase change material 310 changes to a liquid state due to a rise in the temperature of the lithium secondary battery, the phase change material 310 may remain intact within the polymer resin pack 300.

Accordingly, the liquefied phase change material 310 may be prevented from penetrating into the electrode assembly 100, thereby preventing structural changes such as expansion of the electrode assembly 100. Furthermore, since paraffin, which may be used as the phase change material 310, has flammable properties, the polymer resin pack 300 may block contact with oxygen and flame, thereby preventing combustion of the paraffin.

When the polymer resin pack 300 comprises an epoxy resin, the density of the epoxy resin may be about 1.1 to 1.4 g/cm³. The epoxy resin may have mechanical strength capable of stably accommodating a phase change material 310 by having a density within the above-described range. The heat curing temperature of the epoxy resin may be 50 to 200° C. For example, the heat curing temperature of the epoxy resin may be 60 to 180° C., 70 to 160° C., or 80 to 140° C. The epoxy resin may have mechanical strength, heat resistance, chemical resistance, and electrical insulation properties suitable as a polymer resin pack 300 accommodating a phase change material 310 by having a heat curing temperature within the above-described range. The weight average molecular weight (M_{w}) of the epoxy resin may be 500 to 10,000. For example, the weight average molecular weight of the epoxy resin may be 800 to 1,500. The epoxy resin has a weight-average molecular weight within the above range and may thus have a heat-curing temperature within the above range, thereby exhibiting suitable properties as a polymer resin pack 300.

In the case in which the polymer resin pack 300 comprises a phenol resin, the density of the phenol resin may be approximately 1.2 to 1.4 g/cm³. The phenol resin, having a density within the above range, may have mechanical strength sufficient to stably accommodate a phase change material 310. The heat-curing temperature of the phenol resin may range from 100 to 200° C. For example, the heat-curing temperature of the phenol resin may range from 100 to 180° C., 100 to 160° C., 100 to 140° C., or 100 to 120° C. By having a heat-curing temperature within the above range, the phenol resin may exhibit mechanical strength, heat resistance, chemical resistance, and electrical insulation properties suitable for a polymer resin pack 300 that accommodates a phase change material 310. The weight average molecular weight (M_{w}) of the phenol resin may range from 1,000 to 3,000. For example, the weight average molecular weight of the phenol resin may range from 1,000 to 2,000. Since the phenol resin has a weight average molecular weight within the above range, it may have a heat curing temperature within the above range, thereby exhibiting suitable properties as a polymer resin pack 300.

The thickness of the polymer resin pack 300 may range from 100 to 500 μm. For example, the thickness of the polymer resin pack 300 may range from 150 to 300 μm. If the thickness of the polymer resin pack 300 is less than 100 μm, the mechanical strength, heat resistance, chemical resistance, and electrical insulation of the polymer resin pack 300 may not be sufficiently secured. Consequently, when the lithium secondary battery generates heat or experiences an abnormal condition, the phase change material 310 may not be stably accommodated within the pack. If the thickness of the polymer resin pack 300 exceeds 500 μm, heat conduction to the phase change material 310 may not be smooth, and thus the phase change material 310 may not sufficiently suppress the temperature rise of the lithium secondary battery.

The polymer resin pack 300 may be disposed in an empty space within the battery case 400, and the location thereof is not limited. Since the polymer resin pack 300 is disposed in the empty space within the battery case 400, a separate space for containing the phase change material 310 within the lithium secondary battery unit cell may not be required. Therefore, the temperature rise of the lithium secondary battery may be effectively and economically suppressed.

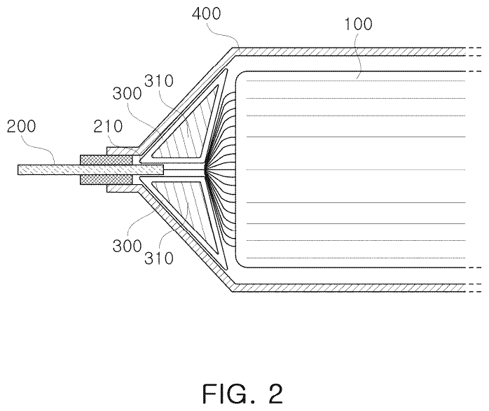

FIG. 2 is a cross-sectional view schematically illustrating a lithium secondary battery in which a polymer resin pack 300 according to an embodiment is disposed between an electrode tab-electrode lead junction 210 and a battery case 400. As illustrated in FIG. 2, a lithium secondary battery according to an embodiment comprises an electrode tab-electrode lead junction 210, in which an electrode tab connected from the electrode assembly 100 and an electrode lead 200 are joined, and the polymer resin pack 300 may be disposed between the electrode tab-electrode lead junction 210 and the battery case 400. The electrode tab-electrode lead junction 210 may generate significant heat during rapid charging or high-power discharge. Furthermore, the space between the electrode tab-electrode lead junction 210 and the battery case 400 corresponds to dead space, which is the empty space of a lithium secondary battery unit cell. Therefore, by disposing the polymer resin pack 300 in the space between the electrode tab-electrode lead junction 210 and the battery case 400, the temperature rise of the lithium secondary battery may be effectively suppressed while also being economical.

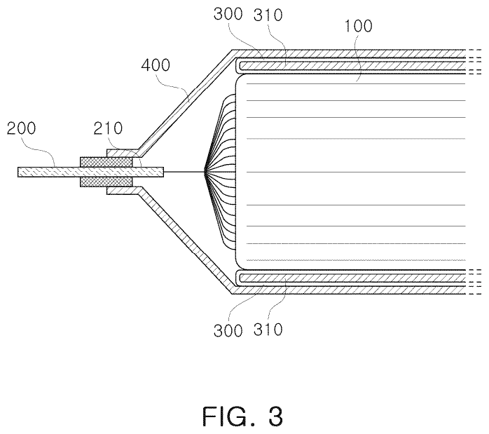

FIG. 3 is a schematic cross-sectional view of a lithium secondary battery according to an embodiment, in which a polymer resin pack 300 is disposed between the outermost surface of the electrode assembly 100 and the battery case 400. As illustrated in FIG. 3, the polymer resin pack 300 may be disposed between the outermost surface of the electrode assembly 100 and the battery case 400. The outermost surface of the electrode assembly 100 refers to the outermost surface in the thickness direction where the electrodes and separator are stacked. The space between the outermost surface of the electrode assembly 100 and the battery case 400 corresponds to the dead space of a lithium secondary battery unit cell. Therefore, disposing the polymer resin pack 300 in the space between the outermost surface of the electrode assembly 100 and the battery case 400 effectively suppresses temperature rise in the lithium secondary battery while also being economical.

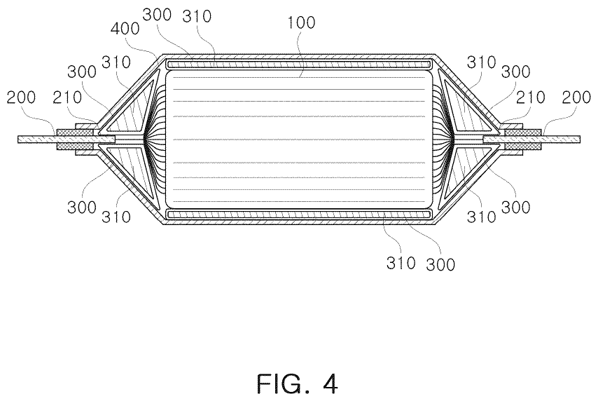

FIG. 4 is a cross-sectional view schematically illustrating a lithium secondary battery in which a polymer resin pack 300 according to an embodiment is disposed between the electrode tab-electrode lead junction 210 and the battery case 400 and between the outermost surface of the electrode assembly 100 and the battery case 400. As described above, by disposing a polymer resin pack 300 containing the phase change material 310 in the space between the electrode tab-electrode lead junction 210 and the battery case 400 and the space between the outermost surface of the electrode assembly 100 and the battery case 400, it is possible to effectively suppress the temperature rise of a lithium secondary battery while being economical.

A method of manufacturing a lithium secondary battery according to an embodiment may comprise an operation of preparing a polymer resin pack containing a phase change material therein, and an operation of disposing the polymer resin pack inside a battery case in which an electrode assembly comprising an electrode is housed. The phase change material and the polymer resin pack may be the same as those used in the lithium secondary battery described above.

The operation of preparing the polymer resin pack containing the phase change material is an operation of packaging the phase change material within the polymer resin pack, and the packaging method is not particularly limited. According to an embodiment, the operation of preparing the polymer resin pack may comprise operations of melting the phase change material; solidifying the melted phase change material into a specific shape; and disposing the solidified phase change material inside the polymer resin pack.

The operation of melting the phase change material may be performed at a temperature of the melting point or more of the phase change material. Heating the phase change material to a temperature of the melting point or more causes a phase change from a solid to a liquid phase, facilitating solidification into a required shape. The heating method for melting the phase change material is not particularly limited. For example, the heating method for melting the phase change material may involve double-boiling and stirring the material in water or oil at a temperature of the melting point or more of the phase change material.

In the operation of solidifying the molten phase change material into a specific shape, the specific shape may refer to a shape that is easily disposable within a lithium secondary battery. For example, the specific shape may be a shape that may be disposed within the space between the electrode tab-electrode lead junction and the battery case of a lithium secondary battery, or between the outermost surface of the electrode assembly and the battery case. The method for solidifying the molten phase change material into a specific shape is not particularly limited. For example, the molten phase change material may be injected into a mold of a specific shape and solidified.

The operation of disposing the solidified phase change material within a polymer resin pack may involve injecting the solidified phase change material into the polymer resin pack and sealing the polymer resin pack.

In another embodiment, the operation of preparing the polymer resin pack may comprise: melting the phase change material; injecting the melted phase change material into the polymer resin pack; and solidifying the phase change material injected into the polymer resin pack.

As described above, directly injecting the melted phase change material into the polymer resin pack to solidify the phase change material simplifies the manufacturing process, making it efficient and economical.

### EXAMPLES

Hereinafter, embodiments of the present disclosure will be further described with reference to specific experimental examples. The examples and comparative examples comprised in the experimental examples are intended to illustrate the present disclosure and do not limit the scope of the appended claims. It will be apparent to those skilled in the art that various modifications and variations of the examples are possible within the scope and spirit of the present disclosure, and it is natural that such modifications and variations fall within the scope of the appended claims.

### Manufacturing Example

### (1) Example 1

1) Manufacturing of Polymer Resin Pack

Paraffin wax, solid at room temperature (25° C.), containing 23 to 25 carbon atoms, was prepared as a phase change material. The prepared paraffin was heated to approximately 65° C. to be melted. At this time, the melting point of the paraffin was approximately 45° C. A mold was then prepared to fit the internal space of the pouch of the lithium secondary battery described in 2) below, and the molten, liquid paraffin was poured into the mold and solidified at room temperature (25° C.). The solidified paraffin, conforming to the internal space of the pouch, was packaged in a prepared envelope-shaped epoxy resin film and sealed to produce a polymer resin pack containing the phase change material.
2) Manufacturing of Lithium Secondary Battery

An anode slurry containing 95% by weight artificial graphite as the anode active material was prepared. The anode slurry was applied onto a 20 μm-thick copper foil (Cu-foil), dried at 120° C., and rolled to produce a 150 μm-thick anode. A cathode slurry containing 94% by weight LiCoO2 as the cathode active material was prepared. The cathode slurry was applied onto a 20 μm-thick aluminum foil (Al-foil), dried at 120° C., and rolled to produce a 150 μm-thick cathode. An electrode assembly was manufactured by interposing a polyolefin separator between the cathode and the anode, as described above.

Thereafter, the electrode assembly was placed in a lithium secondary battery pouch, and the polymer resin pack manufactured according to 1) above was disposed between the electrode tab-electrode lead junction, which is the empty space inside the pouch, and the pouch, and between the outermost surface of the electrode assembly and the pouch. Thereafter, an electrolyte solution containing 1 M LiPF₆ dissolved in a solvent mixed with ethylene carbonate (EC) and diethyl carbonate (DEC) was injected into the secondary battery pouch, followed by sealing, to manufacture a pouch-type lithium secondary battery.

### (2) Comparative Example 1

A lithium secondary battery was manufactured in the same manner as Example 1, except that the polymer resin pack containing the phase change material was not comprised.

### Experimental Example

### (1) Evaluation of Temperature Rise During Discharge in High-Temperature Environment

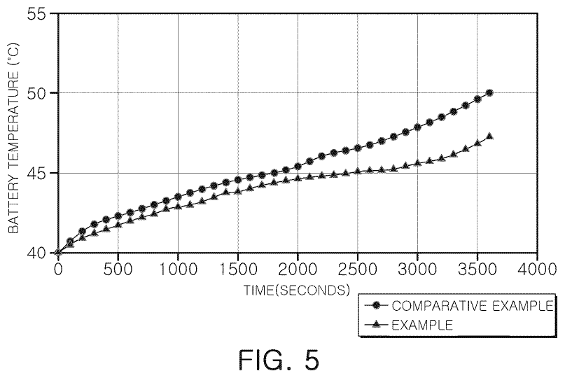

Using the MSMD Battery Equivalent Circuit Model (ECM), an electrochemical-thermal coupling analysis model in Ansys Fluent, models for heat generation and temperature behavior during discharge were developed, reflecting the same properties of lithium secondary batteries manufactured in Example 1 and Comparative Example 1. The initial temperature of the lithium secondary batteries implemented in the model was set to 40° C., and the temperature change during discharge at a 1C rate was measured. The resulting graph is illustrated in FIG. 5.

### (2) Evaluation of Temperature Rise During Battery Penetration

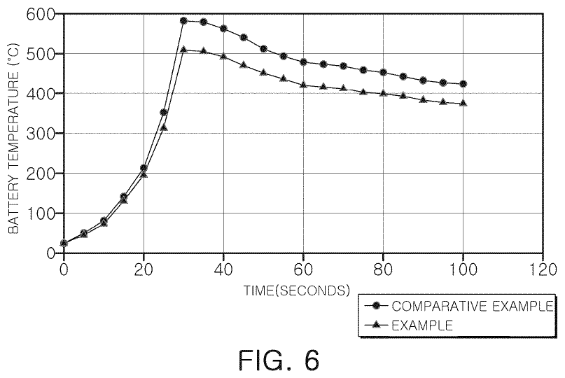

Using the MSMD Battery Equivalent Circuit Model (ECM), an electrochemical-thermal coupling analysis model in Ansys Fluent, models for temperature behavior due to thermal runaway during penetration were developed, reflecting the same properties of lithium secondary batteries manufactured in Example 1 and Comparative Example 1. A 5 mm diameter stainless steel metal nail was inserted into the central portion of the lithium secondary battery implemented in the above model, and the resulting internal short circuit and subsequent exothermic reaction were measured. The resulting temperature changes in the lithium secondary battery were plotted in FIG. 6.

Referring to FIG. 5, the simulation results for a lithium secondary battery implemented identically to Example 1, where a polymer resin pack containing a phase change material was disposed within a pouch, showed that the temperature of the lithium secondary battery rose from a high temperature of 40° C. to 47° C. during discharge. In contrast, the simulation results for a lithium secondary battery implemented identically to Comparative Example 1, where the phase change material was not comprised within the pouch, showed that the temperature of the lithium secondary battery rose to 50° C. This confirms that the heat generated during discharge of the lithium secondary battery was absorbed by the specific heat and latent heat of fusion of the phase change material, thereby suppressing the temperature increase. Therefore, it may be confirmed that disposing a polymer resin pack containing a phase change material within a lithium secondary battery may improve the lifespan characteristics of the lithium secondary battery by suppressing the temperature rise during normal charge/discharge cycles.

Referring to FIG. 6, the simulation results for a lithium secondary battery implemented in the same manner as Example 1, where the polymer resin pack containing the phase change material was disposed within a pouch, show that the temperature of the lithium secondary battery rose to approximately 505° C. during a penetration event. In contrast, the simulation results for a lithium secondary battery implemented in the same manner as Comparative Example 1, where the phase change material was not comprised within the pouch, show that the temperature of the lithium secondary battery rose to approximately 580° C. This confirms that the heat generated during thermal runaway due to penetration of the lithium secondary battery was absorbed by the specific heat and latent heat of fusion of the phase change material, suppressing the temperature increase. Therefore, when disposing a polymer resin pack containing a phase change material inside a lithium secondary battery, it can be confirmed that the temperature rise of a unit cell may be suppressed in abnormal situations such as short circuit, penetration, and impact of a lithium secondary battery, and the transfer of thermal runaway to adjacent cells may be prevented, thereby preventing explosion or fire.

As set forth above, according to an embodiment, the thermal stability of a lithium secondary battery may be improved.

According to an embodiment, the lifespan characteristics of a lithium secondary battery may be improved.

Only specific examples of implementations of certain embodiments are described. Variations, improvements and enhancements of the disclosed embodiments and other embodiments may be made based on the disclosure of this patent document.

What is claimed is:

1. A lithium secondary battery comprising:
an electrode assembly comprising an electrode;
a battery case housing the electrode assembly; and
a polymer resin pack containing a phase change material therein,
wherein the polymer resin pack is disposed within the battery case.

2. The lithium secondary battery of claim 1, wherein the phase change material has a melting point of 40 to 70°C.

3. The lithium secondary battery of claim 1, wherein the phase change material comprises a paraffin having 20 to 40 carbon atoms.

4. The lithium secondary battery of claim 3, wherein the phase change material further comprises a polymer structure and at least one additive.

5. The lithium secondary battery of claim 4, wherein the polymer structure comprises at least one of an acrylic polymer matrix selected from the group consisting of polymethylmethacrylate, polyacrylate, and polymethacrylic acid, and a polyolefin polymer matrix selected from the group consisting of polyethylene, polypropylene, and polybutene.

6. The lithium secondary battery of claim 4, wherein the additive comprises at least one selected from the group consisting of silica (SiO₂), glass fiber, alumina (Al₂O₃), copper (Cu), graphene, carbon nanotubes, dibutyl hydroxy toluene, and polymer wax.

7. The lithium secondary battery of claim 4, wherein the phase change material comprises 49.5 to 99% by weight of the paraffin, 0.5 to 50% by weight of the polymer structure, and 0.5 to 20% by weight of the additive, based on a total weight of the phase change material.

8. The lithium secondary battery of claim 1, wherein the polymer resin pack comprises a thermosetting polymer resin.

9. The lithium secondary battery of claim 8, wherein the thermosetting polymer resin comprises at least one selected from the group consisting of an epoxy resin and a phenol resin.

10. The lithium secondary battery of claim 1, wherein the polymer resin pack has a thickness of 100 to 500 μm.

11. The lithium secondary battery of claim 1, wherein the lithium secondary battery comprises an electrode tab-electrode lead junction in which an electrode tab connected from the electrode assembly and an electrode lead are joined, and
the polymer resin pack is disposed between the electrode tab-electrode lead junction and the battery case.

12. The lithium secondary battery of claim 1, wherein the polymer resin pack is disposed between an outermost surface of the electrode assembly and the battery case.

13. A method of manufacturing a lithium secondary battery, comprising:
preparing a polymer resin pack containing a phase change material therein; and
disposing the polymer resin pack inside a battery case in which an electrode assembly comprising an electrode is housed.

14. The method of claim 13, wherein the preparing the polymer resin pack comprises,
melting a phase change material;
solidifying the melted phase change material into a specific shape; and
disposing the solidified phase change material inside the polymer resin pack.

15. The method of claim 13, wherein the preparing the polymer resin pack comprises,
melting the phase change material;
injecting the melted phase change material into the polymer resin pack; and
solidifying the phase change material injected into the polymer resin pack.
